(19) United States
(12) Patent Application Publication
(10) Pub. No.: US 2007/0171913 A1
(43) Pub. Date: Jul. 26, 2007

(54) NETWORK DEVICE AND CONNECTION SETTING METHOD THEREOF

(75) Inventor: BING-JIUN LUO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/550,803

(22) Filed: Oct. 19, 2006

(30) Foreign Application Priority Data
Jan. 20, 2006 (TW) 095102381

(51) Int. Cl. H04L 12/56

(52) U.S. Cl. 370/395.2

(57) ABSTRACT

A network device (10) for establishing a connection with one of other network devices includes a connection switch module (100) and a connection setting module (110). The connection switch module appoints one of the other network devices with which the network device will establish a connection. The connection setting module is connected to the connection switch module for establishing a connection between the network device and the appointed one of the other network devices. The connection switch module further switches the network device to establish a connection with another one of the other network devices when the connection setting module has failed to establish a connection between the network device and the appointed one of the other network devices.

### BACKGROUND OF THE INVENTION

1. Field of the Invention

The invention relates to network devices, and particularly to a voice over Internet Protocol device and connection setting method thereof.

2. Description of Related Art

Voice over Internet Protocol (VoIP) phones first suppress and encode voice signals, pack the compressed and encoded voice signals, and send the packets to a destination device via the Internet. The destination device decompresses and decodes the packets to retrieve the original voice signals. VoIP services become popular due to low cost thereof.

Gateways and call agents are key devices in VoIP networks. If two terminals need to communicate, logic connection must be first established between a gateway and a call agent respectively communicating with the two terminals. The gateway sends a connection establishing request to the call agent in order to establish a connection therebetween. If the call agent does not respond after a response period, the gateway resends the connection establishing request to the call agent. If the gateway still fails to establish connections with the call agent after resending the connection establishing request to the call agent for several times, the gateway determines that the VoIP network is abnormal, and the two terminals should communicate via a public switched telephone network. After a period, the gateway resends the connection establishing request to the same call agent. Therefore the VoIP connection is established slowly due to sending the connection establishing request to the same call agent, which is inconvenient for users of the terminals.

### SUMMARY OF THE INVENTION

An embodiment of the invention provides a network device for establishing connection with one of other network devices. The network device includes a connection switch module and a connection setting module. The connection switch module appoints the network device to establish connection with one of the other network devices. The connection setting module is connected to the connection switch module for establishing connection between the network device and the one of the other network devices. The connection switch module further switches the network device to establish connection with another one of the other network devices when the connection setting module fails to establish connection between the network device and the one of the other network devices.

Another embodiment of the invention provides a connection setting method for establishing connection between a network device and one of other network devices. The connection setting method includes appointing one of the other network devices to establish connection with the network device; sending a connection establishing request to the appointed one of the other network devices; determining whether the network device establishes connection with the appointed one of the other network devices; determining whether a sending count of the connection establishing request is greater than a first predetermined count if the network device does not establish connection with the appointed one of the other network devices; and appointing another one of the other network devices to establish connection with the network device if the sending count of the connection establishing request is greater than the first predetermined count.

Other advantages and novel features will become more apparent from the following detailed description when taken in conjunction with the accompanying drawings.

### BRIEF DESCRIPTION OF THE DRAWINGS

FIG. 1 is a schematic diagram of a network device of an exemplary embodiment of the invention.

FIG. 2 is a schematic diagram of a network device of another exemplary embodiment of the invention.

FIG. 3 is a schematic diagram of a network device of a further exemplary embodiment of the invention.

FIG. 4 is a flowchart of a connection setting method of an exemplary embodiment of the invention.

FIG. 5 is a flowchart of a connection setting method of another exemplary embodiment of the invention.

FIG. 6 is a flowchart of a connection setting method of a further exemplary embodiment of the invention.

FIG. 7 is a detailed flowchart of FIG. 6.

### DETAILED DESCRIPTION OF THE INVENTION

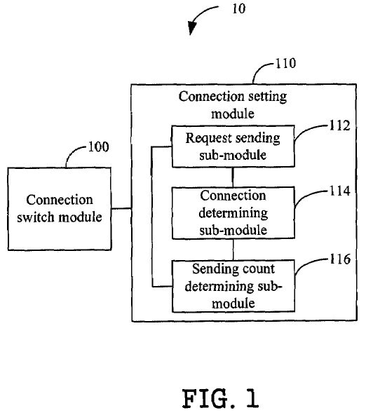

FIG. 1 is a schematic diagram of a network device 10 of an exemplary embodiment of the invention. In the exemplary embodiment, the network device 10 may be a gateway, which needs to establish connection with one of other network devices (not shown). The other network devices may be call agents or soft switches, the other network devices are described as call agents hereinafter for easy and clear specification. The network device 10 includes a connection switch module 100 and a connection setting module 110. The connection setting module 110 is used for establishing connection between the network device 10 and one of the call agents. The connection switch module 100 is connected to the connection setting module 110 for appointing one of the call agents with which the network device 10 will establish a connection based on its recorded connection information, and especially for switching the network device 10 to establish connection with another call agent based on its recorded connection information when the connection setting module 110 has failed to establish connection between the network device 10 and the appointed call agent.

The connection setting module 110 includes a request sending sub-module 112, a connection determining sub-module 114, and a sending count determining sub-module 116. The request sending sub-module 112 is used for sending a connection establishing request to the appointed call agent by the connection switch module 100. In the exemplary embodiment, the connection establishing request may be an RSIP signal. The connection determining sub-module 114 is connected to the request sending sub-module 112, and is used for determining whether the network device 10 has established a connection with the appointed call agent. In the exemplary embodiment, the connection determining sub-module 114 determines whether the network device 10 receives a response from the appointed call agent to the connection establishing request in a first predetermined period, so as to determine whether the network device 10 has established a connection with the appointed call agent.

The sending count determining sub-module 116 is connected to the request sending sub-module 112 and the connection determining sub-module 114, and is used for determining whether a sending count of the connection establishing request by the request sending sub-module 112 is greater than a first predetermined count, and for notifying the connection switch module 100 to appoint another call agent if the sending count is greater than the first predetermined count.

In the exemplary embodiment, the request sending sub-module 114 resends the connection establishing request to the appointed call agent if the connection determining sub-module 114 determines that the network device 10 has failed to establish a connection with the appointed call agent and the sending count of the connection establishing request is not greater than the first predetermined count.

In the exemplary embodiment, the first predetermined period and the first predetermined count may be set according to requirements of users. For example, the first predetermined period may be 10 seconds, and the first predetermined count may be 5.

The request sending sub-module 112 sends a connection establishing request to a call agent appointed by the connection switch module 100, and the connection determining sub-module 114 determines whether the network device 10 has established a connection with the appointed call agent. If a connection has been established, the connection determining sub-module 114 records a flag of the appointed call agent. If a connection has not been established, the sending count determining sub-module 116 determines whether a sending count of the connection establishing request by the request sending sub-module 112 is greater than the first predetermined count. If the sending count is not greater than the first predetermined count, the requesting sending sub-module 112 continues to send the connection establishing request to the appointed call agent. If the sending count is greater than the first predetermined count, the connection switch module 100 appointed another call agent.

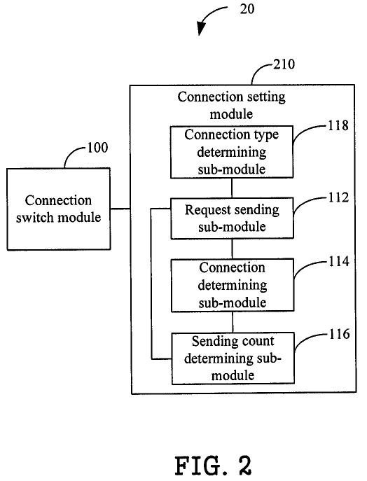

FIG. 2 is a schematic diagram of a network device 20 of another exemplary embodiment of the invention. The difference between the network device 20 and the network device 10 is that a connection setting module 210 of the network device 20 further includes a connection type determining sub-module 118. Other modules of the network device 20 are same as those of the network device 10, therefore, descriptions thereof are omitted. The connection type determining sub-module 118 is used for determining a connection type of a connection between the network device 20 and an appointed call agent and sending the connection type to the request sending sub-module 112. In the exemplary embodiment, the connection type includes an established type and a first time type. The established type may represent that the network device 20 has previously established connection with the appointed call agent. The first time type may represent that the network device 20 has never previously established connection with the appointed call agent.

The network device 20 records flags of the call agents that establish connection with the network device 20. When the network device 20 is powered on, the connection switch module 100 appoints one of the call agents according to the record of flags. The connection type determining sub-module 118 determines a connection type of a connection that needs to be established between the network device 20 and the appointed call agent, and sends the connection type to the request sending sub-module 112. The request sending sub-module 112 sends a connection establishing request including the connection type to the appointed call agent. If a connection is an established type, the appointed call agent receives the connection establishing request, deletes old data of the network device 20, and establishes a new connection with the network device 20.

The connection determining sub-module 114 determines whether a connection has been established between the network device 20 and the appointed call agent. If a connection has been established, the connection determining sub-module 114 records a flag of the appointed call agent. If a connection has not been established, the sending count determining sub-module 116 determines whether the sending count of the connection establishing request is greater than the first predetermined count. If the sending count is not greater than the first predetermined count, the request sending sub-module 112 continues to send the connection establishing request to the appointed call agent. If the sending count is greater than the first predetermined count, the connection switch module 100 appoints another call agent with which to establish a connection.

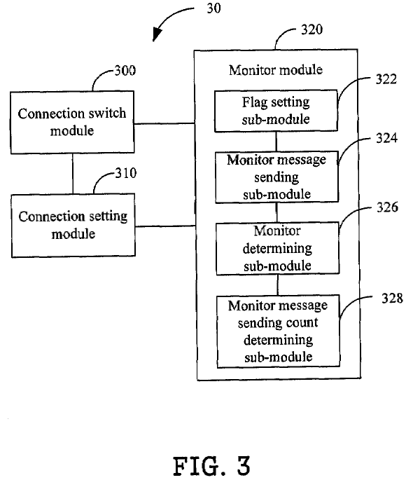

FIG. 3 is a schematic diagram of a network device 30 of a further exemplary embodiment of the invention. The difference between the network device 30 and the network devices 10 and 20 is that the network device 30 further includes a monitor module 320. The connection setting module 310 and the connection switch module 300 of the network device 30 are the same as those of the network device 10 and/or the network device 20, therefore, descriptions thereof are omitted.

The monitor module 320 is connected to the connection switch module 300 and the connection setting module 310 for monitoring any connection between the network device 30 and one of the call agents appointed by the connection switch module 300. In the exemplary embodiment, the connection setting module 310 further sends a recorded flag of the appointed call agent to the monitor module 320. The monitor module 320 includes a flag setting sub-module 322, a monitor message sending sub-module 324, a monitor determining sub-module 326, and a monitor message sending count determining sub-module 328. The flag setting sub-module 322 is used for setting a flag of a current call agent as the flag of a call agent connecting with the network device 30, that is, the flag of the appointed call agent received from the connection setting module 310. The monitor message sending sub-module 324 is connected to the flag setting sub-module 322 for sending a monitor message to the call agent corresponding to the flag, that is, sending the monitor message to the appointed call agent.

The monitor determining sub-module 326 is connected to the monitor message sending sub-module 324, and is used for determining whether the network device 30 receives a response to the monitor message from the appointed call agent in a second predetermined period. The monitor message sending count determining sub-module 328 is connected to the monitor message sending sub-module 324 and the monitor determining sub-module 326, and is used for determining whether a sending count of the monitor message by the monitor message sending sub-module 324 is greater than a second predetermined count when the monitor determining sub-module 326 does not receive a response to the monitor message from the appointed call agent in the second predetermined period.

If the sending count of the monitor message is greater than the second predetermined count, the monitor message sending count determining sub-module 328 notifies the connection switch module 300 that a connection between the network device 30 and the appointed call agent is broken down. If the sending count of the monitor message is not greater than the second predetermined count, the monitor message sending sub-module 324 resends the monitor message to the appointed call agent. If the network device 30 receives the response to the monitor messages from the appointed call agent in the second predetermined period, the monitor message sending sub-module 324 sends another monitor message to the appointed call agent.

In the exemplary embodiment, the second predetermined period and the second predetermined count may be set according to requirements of users. For example, the second predetermined period may be 10 seconds, and the second predetermined count may be 5.

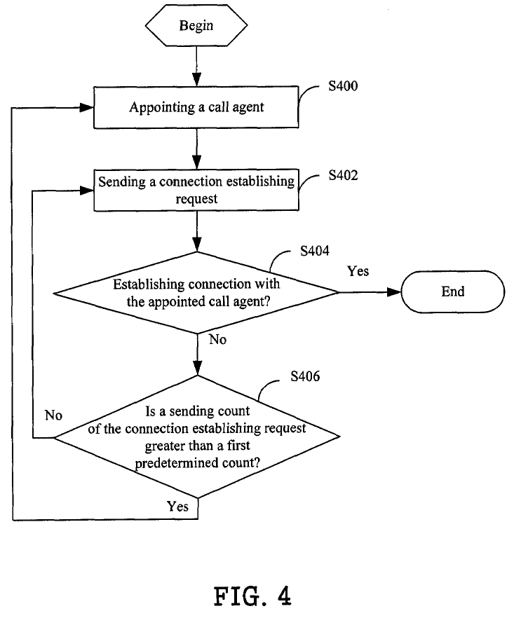

FIG. 4 is a flowchart of a connection setting method of an exemplary embodiment of the invention. In step S400, the connection switch module 100 of the network device 10 appoints a call agent with which to establish a connection based on its saved connection information. In step S402, the request sending sub-module 112 sends a connection establishing request to the appointed call agent.

In step S404, the connection determining sub-module 114 determines whether the network device 10 has established a connection with the appointed call agent. In the exemplary embodiment, the connection determining sub-module 114 determines whether the network device 10 receives a response to the connection establishing request from the appointed call agent in the first predetermined period. If the network device 10 receives the response from the appointed call agent in the first predetermined period, the connection determining sub-module 114 determines that the network device 10 has established a connection with the appointed call agent. Otherwise, the connection determining sub-module 114 determines that the network device 10 has not established a connection with the appointed call agent.

If a connection between the network device 10 and the appointed call agent has been established, the process ends.

If a connection between the network device 10 and the appointed call agent is not established, in step S406, the sending count determining sub-module 116 determines whether a sending count of the connection establishing request by the request sending sub-module 112 is greater than the first predetermined count.

If the sending count of the connection establishing request is not greater than the first predetermined count, the process returns to step S402. That is, the request sending sub-module 112 continues to send the connection establishing request to the appointed call agent.

If the sending count of the connection establishing request is greater than the first predetermined count, the process returns to step S400. That is, the connection switch module 100 appoints another call agent with which to establish a connection.

The network device 20 and 30 also have flowcharts of a connection setting method same as that of the network device 10, therefore, descriptions are omitted.

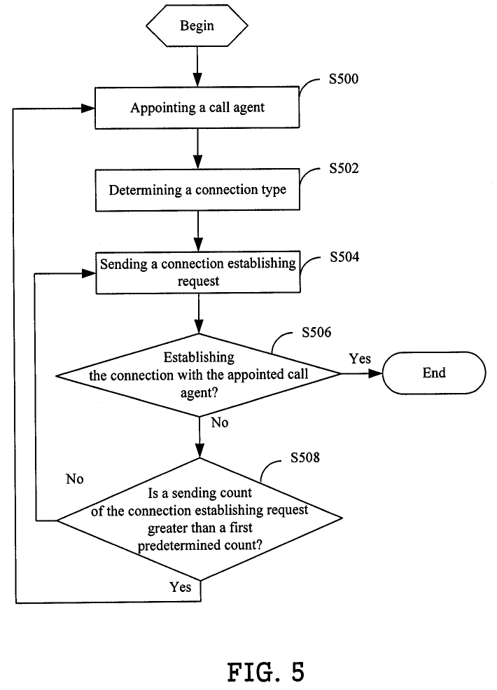

FIG. 5 is a flowchart of a connection setting method of another exemplary embodiment of the invention. In step S500, the connection switch module 100 of the network device 20 appoints a call agent with which to establish a connection. In step S502, the connection type determining sub-module 118 determines a connection type of a connection that needs to be established between the network device 20 and the appointed call agent.

In step S504, the request sending sub-module 112 sends a connection establishing request to the appointed call agent. In the exemplary embodiment, the connection establishing request includes the connection type of the connection that needs to be established between the network device 20 and the appointed call agent.

In step S506, the connection determining sub-module 114 determines whether the network device 20 has established a connection with the appointed call agent. In the exemplary embodiment, the connection determining sub-module 114 determines whether the network device 20 receives a response to the connection establishing request from the appointed call agent in the first predetermined period. If the network device 20 receives the response from the appointed call agent in the first predetermined period, the connection determining sub-module 114 determines that the network device 20 has established a connection with the appointed call agent. Otherwise, the connection determining sub-module 114 determines that the network device 20 has not established a connection with the appointed call agent.

If a connection between the network device 20 and the appointed call agent has been established, the process ends.

If a connection between the network device 20 and the appointed call agent has not been established, in step S508, the sending count determining sub-module 116 determines whether a sending count of the connection establishing request by the request sending sub-module 112 is greater than the first predetermined count.

If the sending count of the connection establishing request is not greater than the first predetermined count, the process returns to step S504. That is, the request sending sub-module 112 continues to send the connection establishing request to the appointed call agent.

If the sending count of the connection establishing request is greater than the first predetermined count, the process returns to step S500. That is, the connection switch module 100 appoints another call agent with which to establish a connection.

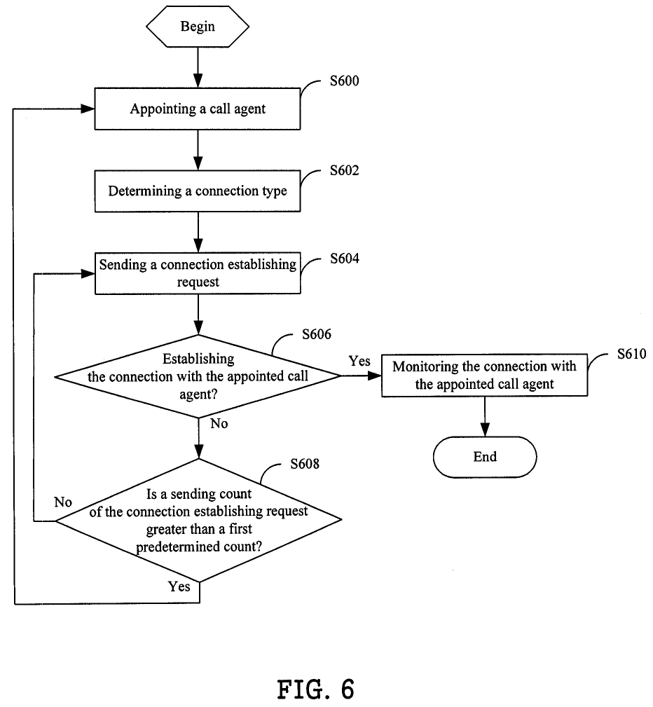

FIG. 6 is a flowchart of a connection setting method of a further exemplary embodiment of the invention. In step S600, the connection switch module 300 of the network device 30 appoints a call agent with which to establish a connection. In step S602, a connection type determining sub-module of the connection setting module 310 determines a connection type of a connection that needs to be established between the network device 30 and the appointed call agent. In alternative embodiments, step S602 may be omitted.

In step S604, a request sending sub-module of the connection setting module 310 sends a connection establishing request to the appointed call agent. In the exemplary embodiment, the connection establishing request includes the connection type of the connection that needs to be established between the network device 30 and the appointed call agent.

In step S606, a connection determining sub-module of the connection setting module 310 determines whether the network device 30 has established a connection with the appointed call agent. In the exemplary embodiment, the connection determining sub-module of the connection setting module 310 determines whether the network device 30 receives a response to the connection establishing request from the appointed call agent in the first predetermined period. If the network device 30 receives the response from the appointed call agent in the first predetermined period, the connection determining sub-module of the connection setting module 310 determines that the network device 30 has established a connection with the appointed call agent. Otherwise, the connection determining sub-module determines that the network device 30 has not established a connection with the appointed call agent.

If a connection between the network device 30 and the appointed call agent has been established, in step S610, the connection determining sub-module of the connection setting module 310 records a flag of the appointed call agent, and the monitor module 320 monitors the connection with the appointed call agent.

If a connection between the network device 30 and the appointed call agent has not been established, in step S608, a sending count determining sub-module of the connection setting module 310 determines whether a sending count of the connection establishing request by the request sending sub-module is greater than the first predetermined count.

If the sending count of the connection establishing request is not greater than the first predetermined count, the process returns to step S604. That is, the request sending sub-module of the connection setting module 310 continues to send the connection establishing request to the appointed call agent.

If the sending count of the connection establishing request is greater than the first predetermined count, the process returns to step S600. That is, the connection switch module 300 appoints another call agent with which to establish a connection.

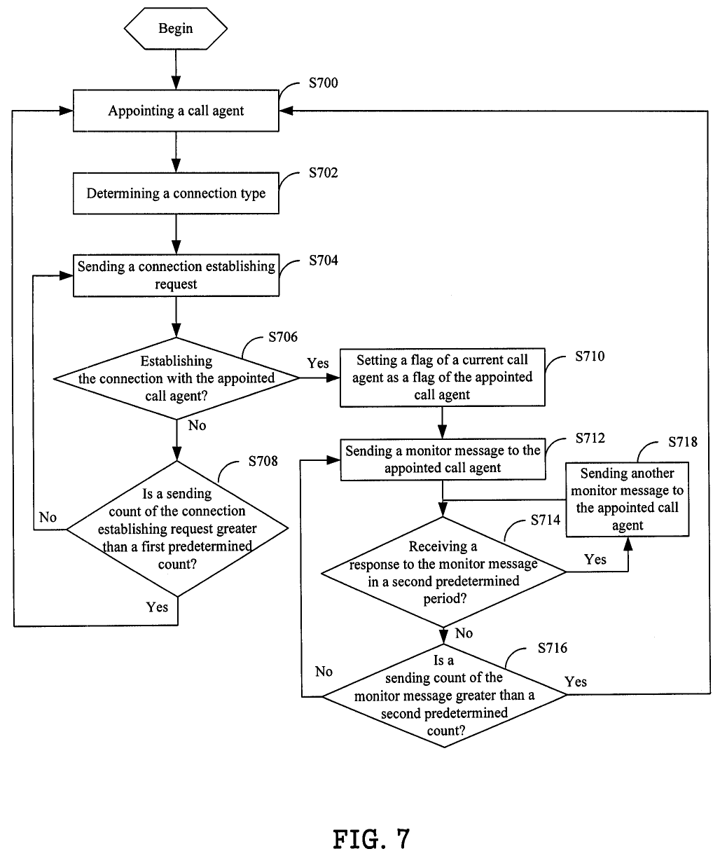

FIG. 7 is a detailed flowchart of FIG. 6. In the exemplary embodiment, steps S700, S702, S704, S706, and S708 are same as corresponding steps S600, S602, S604, S606, and S608. Therefore, descriptions are omitted. Steps S710, S712, S714, S716, and S718 are detailed steps of step S610 of FIG. 6.

In step S710, the flag setting sub-module 322 sets a flag of a current call agent as a flag of the appointed call agent. In step S712, the monitor message sending sub-module 324 sends a monitor message to the appointed call agent.

In step S714, the monitor determining sub-module 326 determines whether the network device 30 receives a response to the monitor message from the appointed call agent in the second predetermined period.

If the network device 30 receives a response from the appointed call agent in the second predetermined period, in step S718, the monitor message sending sub-module 324 sends another monitor message to the appointed call agent.

If the network device 30 does not receive a response from the appointed call agent in the second predetermined period, in step S716, the monitor message sending count determining sub-module 328 determines whether a sending count of the monitor message by the monitor message sending sub-module 324 is greater than the second predetermined count.

If the sending count of the monitor message is greater than the second predetermined count, the process returns to step S700. That is, the connection switch module 300 appointed another call agent with which to establish a connection.

If the sending count of the monitor message is not greater than the second predetermined count, the process returns to step S712. That is, the monitor message sending sub-module 324 resends the monitor message to the appointed call agent.

If the network devices 10, 20, 30 fail to establish a connection with a call agent after sending connection establishing requests for several counts, the network devices 10, 20, 30 automatically appoint another call agent to send connection establishing requests to establish a connection. Thus, connections between the network devices 10, 20, 30 and call agents can be rapidly established.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A network device, for establishing connection with one of other network devices, comprising:
a connection switch module, for appointing one of the other network devices with which the network device will establish a connection; and
a connection setting module connected to the connection switch module, for establishing a connection between the network device and the appointed one of the other network devices;
wherein the connection switch module is further used for switching the network device to establish a connection with another one of the other network devices when the connection setting module has failed to establish a connection between the network device and the appointed one of the other network devices.

2. The network device of claim 1, wherein the connection setting module comprises:
a request sending sub-module, for sending a connection establishing request to the appointed one of the other network devices;
a connection determining sub-module connected to the request sending sub-module, for determining whether the network device has established a connection with the appointed one of the other network devices; and
a sending count determining sub-module connected to the request sending sub-module and the connection determining sub-module, for determining whether a sending count of the connection establishing request by the request sending sub-module is greater than a first predetermined count.

3. The network device of claim 2, wherein the connection setting module further comprises a connection type determining sub-module connected to the request sending sub-module, for determining a connection type of the connection between the network device and the appointed one of the other network devices and sending the connection type to the request sending sub-module.

4. The network device of claim 3, wherein the connection type comprises an established type and a first time type.

5. The network device of claim 2, wherein the connection determining sub-module further determines whether the network device receives a response to the connection establishing request from the appointed one of the other network devices in a first predetermined period.

6. The network device of claim 2, wherein the connection determining sub-module records a flag of one of the other network devices that has established a connection with the network device.

7. The network device of claim 6, further comprising a monitor module connected to the connection switch module and the connection setting module, for monitoring a connection between the network device and the one of the other network devices that has established the connection with the network device.

8. The network device of claim 7, wherein the monitor module comprises:
a flag setting sub-module, for setting a flag of a current one of the other network devices as the flag of the one of the other network devices that has established the connection with the network device;
a monitor message sending sub-module connected to the flag setting sub-module, for sending a monitor message to the one of the other network devices corresponding to the flag; and
a monitor determining sub-module connected to the monitor message sending sub-module, for determining whether the network device receives a response to the monitor message from the one of the other network devices corresponding to the flag in a second predetermined period.

9. The network device of claim 8, wherein the monitor module further comprises a monitor message sending count determining sub-module connected to the monitor determining sub-module and the monitor message sending sub-module, for determining whether a sending count of the monitor message by the monitor message sending sub-module is greater than a second predetermined count and notifying the connection switch module that the connection between the network device and the one of the other network devices that has established the connection with the network device is broken down.

10. The network device of claim 9, wherein the monitor message sending sub-module further resends the monitor message to the one of the other network devices corresponding to the flag when the network device does not receive the response to the monitor message from the one of the other network devices corresponding to the flag in the second predetermined period, and sends another monitor message to the one of the other network devices corresponding to the flag when the network device receives the response to the monitor message from the one of the other network devices corresponding to the flag in the second predetermined period.

11. The network device of claim 1, wherein the network device comprises a gateway.

12. A connection setting method, for establishing a connection between a network device and one of other network devices, comprising:
appointing one of the other network devices with which the network device will establish a connection;
sending a connection establishing request to the appointed one of the other network devices;
determining whether the network device has established a connection with the appointed one of the other network devices;
determining whether a sending count of the connection establishing request is greater than a first predetermined count if the network device has not established a connection with the appointed one of the other network devices; and
appointing another one of the other network devices with which the network device will establish a connection if the sending count of the connection establishing request is greater than the first predetermined count.

13. The connection setting method of claim 12, further comprising steps of:
resending the connection establishing request to the appointed one of the other network devices if the sending count of the connection establishing request is not greater than the first predetermined count.

14. The connection setting method of claim 12, wherein the step of determining whether the network device has established a connection with the appointed one of the other network devices comprises steps of:
determining whether the network device receives a response to the connection establishing request from the appointed one of the other network devices in a first predetermined period.

15. The connection setting method of claim 14, further comprising steps of:
recording a flag of the appointed one of the other network devices if the network device receives the response to the connection establishing request in the first predetermined period; and
monitoring the connection between the network device and the appointed one of the other network devices.

16. The connection setting method of claim 15, wherein the step of monitoring the connection between the network device and the appointed one of the other network devices comprises steps of:
setting a flag of a current one of the other network devices as the flag of the appointed one of the other network devices;
sending a monitor message to the appointed one of the other network devices;
determining whether the network device receives a response to the monitor message from the appointed one of the other network devices in a second predetermined period; and
if yes, sending another monitoring message to the appointed one of the other network devices.

17. The connection setting method of claim 16, wherein the step of monitoring the connection between the network device and the appointed one of the other network devices further comprises steps of:
if not, determining whether a sending count of the monitor message is greater than a second predetermined count;
appointing another one of the other network devices with which the network device will establish a connection if the sending count of the monitor message is greater than the second predetermined count; and
resending the monitor message to the appointed one of the other network devices if the sending count of the monitor message is not greater than the second predetermined count.

18. The connection setting method of claim 12, further comprising steps of:
determining a connection type of a connection that needs to be established between the network device and the appointed one of the other network devices.

19. A method for establishing connection between a network device of a first type and one of network devices of a second type, comprising the steps of:
recording, in a network device of a first type, connection information of at least two of network devices of a second type to connect with said network device of said first type;
appointing a selective one of network devices of said second type to connect therewith in said network device of said first type by using said connection information;
sending a connection establishing request from said network device of said first type to said selective one of network devices of said second type;
verifying establishment of connection between said network device of said first type and said selective one of network devices of said second type according to said connection establishing request; and
appointing another selective one of network devices of said second type to connect therewith in said network device of said first type by using said connection information when said network device of said first type is verified as failing to connect with said selective one of network devices of said second type.

20. The method of claim 19, further comprising the step of resending said connection establishing request from said network device of said first type to said selective one of said network devices of said second type based on a preset count when said network device of said first type does not establish connection with said selective one of said network devices of said second type according to said previously-sent connection establishing request.
